(19) United States
(12) Patent Application Publication
(10) Pub. No.: US 2025/0026037 A1
(43) Pub. Date: Jan. 23, 2025

(54) RAZOR INTERCONNECTING MECHANISM

(71) Applicant: BIC Violex Single Member S.A., Anoixi (GR)

(72) Inventors: Maria KANIDI, Anoixi (GR); Polykarpos PSAROPOULOS, Anoixi (GR); Dimitrios EFTHIMIADIS, Anoixi (GR)

(73) Assignee: BIC Violex Single Member S.A., Anoixi (GR)

(21) Appl. No.: 18/756,836

(22) Filed: Jun. 27, 2024

(30) Foreign Application Priority Data
Jul. 18, 2023 (EP) 23186092.5

(51) Int. Cl. B26B 21/52; B26B 21/22

(52) U.S. Cl. CPC B26B 21/521; B26B 21/225

(57) ABSTRACT

An interconnecting mechanism for engaging a blade assembly to a razor handle including: an adaptor extending between a handle engaging portion and a cartridge engaging portion, a connector configured to be coupled with the handle engaging portion, the connector including one or more outer threads, a rotatable element including one or more inner threads, wherein the inner threads of the rotatable element are configured to mate with the outer threads of the connector.

### CROSS-REFERENCE TO RELATED APPLICATIONS

This application claims priority from European patent application No. 23186092, filed on Jul. 18, 2023, the contents of which are hereby incorporated herein in their entirety by this reference.

### TECHNICAL FIELD

The present disclosure relates to an interconnecting mechanism for engaging a razor head to a razor handle, and a razor handle comprising the interconnecting mechanism.

### BACKGROUND

Razors are handheld devices that are widely used for shaving unwanted hair from various parts of the body such as the face, legs and underarm. Conventional razors typically include a handle and a blade assembly, which contains a plurality of cutting elements (blades). Over time, the blades in the blade assembly become dull and therefore the blade assembly must be replaced. However, conventional razor designs often do not allow for easy replacement of the blade assembly, resulting in wastefulness and inconvenience for the user.

Additionally, there is a growing demand for razors that can accommodate various handle designs and materials, providing consumers with greater customization options and improved ergonomics. However, existing razor designs often lack the flexibility required to accommodate different handle designs.

To address these challenges, there is a constant need to develop interconnecting mechanisms that allow for easy replacement of the blade assembly when the blades become dull, while also providing the flexibility to accommodate various handle designs.

### SUMMARY

According to an aspect of the disclosure an interconnecting mechanism for engaging a blade assembly to a razor handle is provided. The interconnecting mechanism comprises:
an adaptor extending between a handle engaging portion and a cartridge engaging portion,
a connector configured to be coupled with the handle engaging portion, the connector comprising one or more outer threads,
a rotatable element comprising one or more inner threads.

The inner threads of the rotatable element are configured to mate with the outer threads of the connector.

The interconnecting mechanism is thus designed to securely connect a handle and a blade assembly together, while also allowing for quick and easy detachment of the blade assembly for replacement purposes.

Furthermore, the interconnecting mechanism is designed to be compatible with a variety of handle designs made of different materials, allowing users to select a handle that meets their individual preferences. This provides users with greater convenience, flexibility, and customization options.

In embodiments, the connector may comprise a solid portion that may comprise the outer threads and a deformable portion extending from the solid portion.

In embodiments, the deformable portion of the connector may comprise one or more elastic projections.

In embodiments, the connector may be fixedly attached to the handle engaging portion of the adaptor.

In embodiments, an inner area of the rotatable element may comprise a contacting surface configures such that when the rotatable element is rotated towards an engagement direction, the contacting surface deforms the elastic projections thereby connecting the rotatable element to the adaptor. Rotation of the rotatable element may also allow for a handle to be connected to the adaptor at the same time as it will be explained later in this description.

In embodiments, the rotatable element may have a ring shape.

In embodiments, the elastic projections may extend outwardly from the solid portion of the connector.

In embodiments, the connector may comprise a pair of hooks. The handle engaging portion of the adaptor may comprise an inner wall and the hooks may be configured to be coupled to the inner wall of the adaptor.

In embodiments, at least one hook of the pair of hooks may comprise a finger having an angled profile having a bearing length and at least one chamfer. The chamfer may be engaged to the inner wall.

In embodiments, the adaptor may comprise a stop structure that may be configured to limit the movement of the connector inside the adaptor. The stop structure may comprise a substantially flat surface and a projection extending from the flat surface.

In embodiments, when the adaptor and the connector are in an engaged position, at least a part of the bearing length of the finger of the hooks may be in contact with the flat surface of the stop structure.

In embodiments, at least one hook of the pair of hooks may comprise a raised portion arranged facing the other hook of the pair of hooks and configured such that a distal end of a razor handle can be connected to the adaptor.

In embodiments, the raised portion comprises at least one facet, wherein the at least one facet is adapted to engage a protrusion of a razor handle.

According to another aspect of the disclosure a razor handle is provided. The razor handle extends between a distal end and a proximal end. The distal end comprises a protrusion having a first coupling region and a second coupling region that is structurally different from the first coupling region. The handle comprises the interconnecting mechanism substantially as described above coupled at its distal end.

In embodiments, the first coupling region may comprise a cut-out surface and the second coupling region may comprise a conical surface.

In embodiments, the pair of hooks may define a channel for receiving the protrusion of the handle. The channel may be shaped such that the cut-out surface of the protrusion can slide inside the adaptor.

In embodiments, the shape of the channel may be identical or complementary with the shape of the cut-out surface of the protrusion of the handle. In that way, the handle can only be inserted to the adaptor only with a specific position and to be thereby safely secured.

In embodiments, when the rotatable element is rotated in an engagement direction and deforms the elastic projections, the elastic projections engage the handle to the adaptor.

According to a further aspect of the disclosure, a kit of parts is provided. The kit comprises the interconnecting mechanism substantially as described herein, the razor handle substantially as described herein and a blade assembly comprising one or more blades.

Throughout the following description and claims the term “engaged position” should be understood as the state where the adaptor is removably connected to a razor handle.

Throughout the following description and claims the term “engagement direction” should be understood as the direction towards which the rotatable element is fastened or coupled to the connector.

Additional objects, details and features of embodiments are described in reference to the drawings as follows.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIG. 1 is a partial exploded view of an interconnecting mechanism according to embodiments including an adaptor and a razor handle.

FIG. 2 is a partial view of a razor handle.

FIG. 3 is a schematic cutaway side view of the rotatable element along cross section line A-A.

FIG. 4 is a schematic cutaway side view of the connector along cross section line A-A.

FIG. 5A to 5C are schematic side views of the interconnecting mechanism and of the distal end of a handle.

FIG. 6 is a detailed cutaway view of the handle engaging portion of the handle.

FIG. 7 is an exploded view of a razor comprising a blade assembly, an interconnecting mechanism and a razor handle.

### DETAILED DESCRIPTION

Embodiments of the interconnecting mechanism will be described in reference to the drawings as follows.

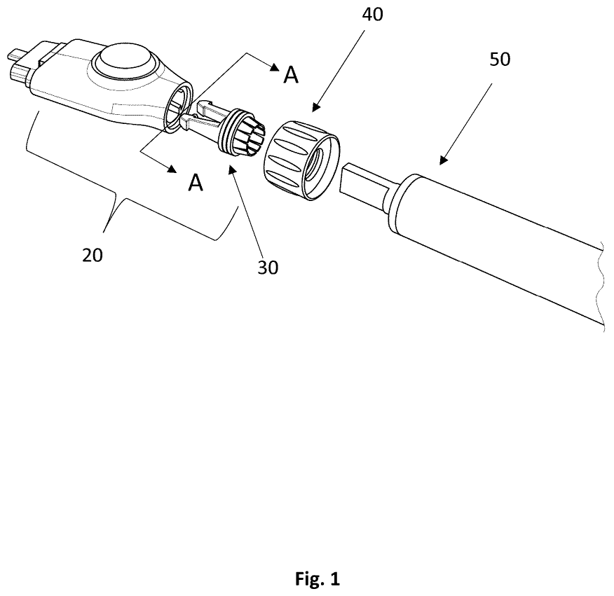

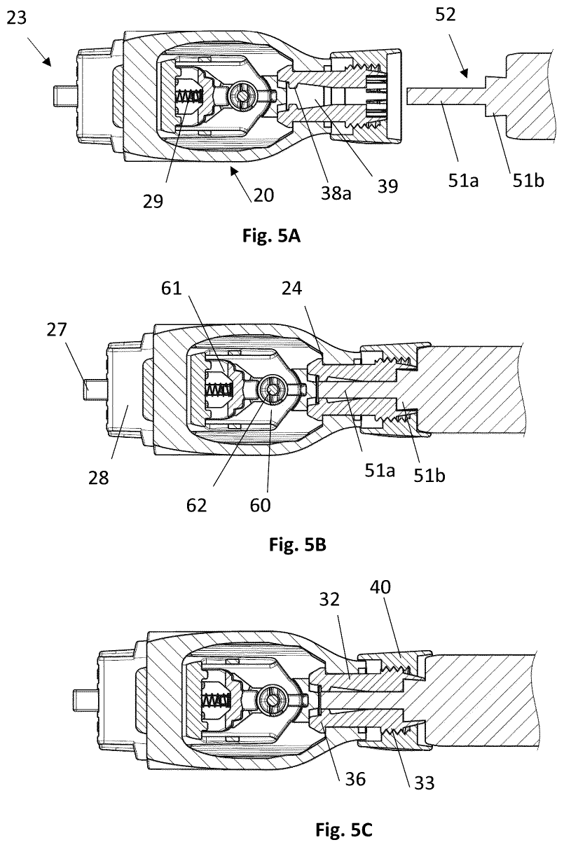

FIG. 1 shows an exploded view of the interconnecting mechanism and a portion of a razor handle 50. The interconnecting mechanism comprises an adaptor 20 that extends between a handle engaging portion 22 and a cartridge engaging portion 23, as shown for example in FIG. 5A. The handle engaging portion 22 is configured for selectively engaging the adaptor 20 to a razor handle 50 while the cartridge engaging portion 23 is configured for selectively engaging the adaptor 20 to a blade assembly 200.

In examples, the handle engaging portion 22 and the cartridge engaging portion 23 may be integrally formed, meaning they can be constructed as a unitary piece, the adaptor 20. The interconnecting mechanism further comprises a connector 30 that is coupled with the handle engaging portion 22 and a rotatable element 40 that is configured to be fastened to the connector 30. In detail, the rotatable element 40 comprises inner threads 43 that may be provided in an inner area 41 of the rotatable element 40 as shown in FIG. 3. The connector 30 respectively, comprises outer threads 33. The inner threads 43 and outer threads 33 are configured to mate together, when the rotatable element 40 is rotated towards the engagement direction, thereby ensuring secure fastening of the rotatable element 40 to connector 30 and consequently safe attachment of the adaptor 20 to e.g., a razor handle 50. For disengaging the razor handle 50 respectively, the rotatable element 40 may be rotated to a direction that is opposite to the engagement direction so as the connection of the rotatable element and the connector 30 becomes loose, thereby allowing to pull out the razor handle 50.

In embodiments, the connector 30 comprises a solid portion 32 and a deformable portion 31 extending from the solid portion 32, as shown in FIG. 4. In examples, the solid portion 32 comprises the outer threads 33 that mate with the inner threads 43 of the rotatable element 40. The handle engaging portion 22 comprises a receptacle for receiving at least a part of the solid portion 32 of the connector 30. In examples, the part of the solid portion 32 that is not received within the receptacle of the handle engaging portion 22 comprises the outer threads 33.

In examples, the connector 30 comprises a pair of hooks 36. Hooks 36 may extend from the outer threads 33 in a direction facing towards the receptacle of the handle engaging portion 22. In examples, the handle engaging portion 22 comprises an inner wall 24 and the hooks 36 are configured to be coupled to the inner wall 24, thereby securing the connector 30 to the adaptor 20. In examples, the connector 30 is fixedly attached to the adaptor 20, and more specifically to the inner wall 24 of the handle engaging portion 22 of the adaptor 20. In that way, the adaptor 20 and the connector 30 substantially form a single piece, thereby minimizing the components when a full razor system (meaning the blade assembly, the interconnecting mechanism and the handle) is disassembled and consequently facilitating the user to engage and easily disengage the various components of the razor system such as e.g., different handles.

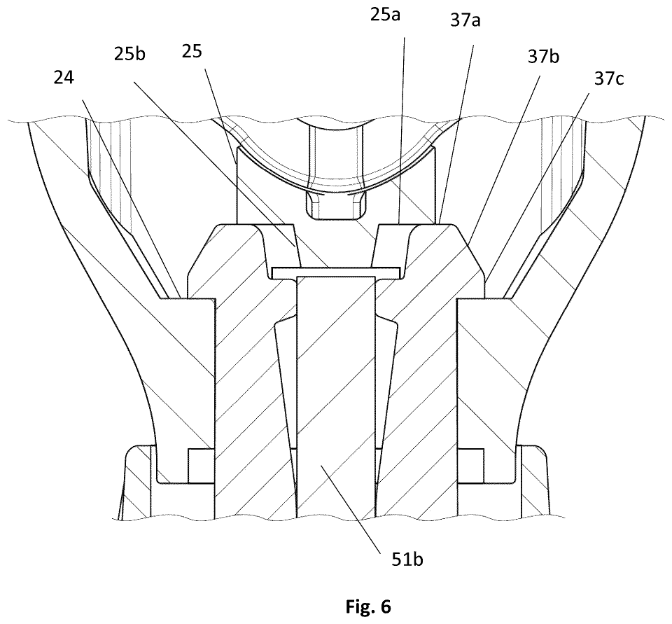

In examples, at least one hook 36 from the pair of hooks 36 comprises a finger 37 that has an angled profile. The angled profile comprises a bearing length 37a which in an example may be substantially horizontal as shown in FIG. 6. As further shown in FIG. 6, the angled profile also comprises at least one chamfer 37b. In the frame of the current disclosure, the term “chamfer” should be understood as an angled cut in a material at an angle that should be less than 90 degrees relative to the most proximate surface. In examples, the angled profile comprises two chamfers 37b, 37c. In further examples, more chamfers may be foreseen. The finger 37 is coupled to the inner wall 24 of the adaptor 20, in particular in an indentation of the inner wall 24. In examples where both hooks of the pair of hooks 36 comprise the finger 37, each finger 37 may be coupled to respective indentations of the inner wall 24 of the handle engaging portion 22. Such an arrangement prevents any undesired release of the connector 30 from the handle engaging portion 22.

In examples, an inside of adaptor 20 comprises a stop structure 25 that is configured to limit the movement of the connector 30 inside the adaptor 20, particularly limiting insertion movement of the hooks 36. The stop structure 25 comprises a substantially flat surface 25a and a projection 25b that extends from that flat surface 25a. When in an engaged position, at least a part of the bearing length 37a of the finger 37 of the hooks 36 is in contact with the flat surface 25a of the stop structure 25. In that way, an additional way, supplementary to the chamfer(s) of the finger(s) of the hooks 36 that are retained by indentation(s) of the inner wall 24 of the adaptor 20, is provided, to ensure safe attachment of the connector 30 to the handle engaging portion 22 of the adaptor 20.

In examples, at least one hook of the pair of hooks 36 comprises a raised portion 38 arranged facing the other hook of the pair of hooks 36. The raised portion 38 is configured such that a distal end of a razor handle 50 can be connected to the adaptor 20. The raised portion 38 is designed/shaped such that, when in an engaged position, engages a protrusion 51 of the razor handle 50, more specifically, a cut-out surface 51a, as shown for example in FIG. 5A or 5B. In that way, any undesired movement of the protrusion 51 and consequently of the razor handle 50 is prevented. In examples, the raised portion 38 may comprise at least one facet 38a. The at least one facet 38a is adapted to engage the protrusion 51 of the distal end of handle 50. Facet 38a serves to prevent the elastic deformation of the at least one hook or of the pair of hooks 36 from disengagement of the inner wall 24 once the protrusion 51 of the handle 50, and more specifically the second coupling region 51b is inserted to the adaptor 20.

In examples, as shown in FIG. 1, the rotatable element 40 is ring-shaped. By having the rotatable element 40 shaped as a ring, and therefore cylindrical, optimized fastening of the rotatable element 40 to the connector 30 may be foreseen since the inner threads 43 of the rotatable element 40 can be better screwed to the respective outer threads 33 of the connector 30 without the risk of being undesirably loosened and therefore to disconnect the other components.

In examples, the deformable portion 31 of the connector 30 comprises one or more elastic projections 311. The projections 311 may extend outwardly from the solid portion 32 of the connector 30 in a direction that is opposite to the direction of the pair of hooks 36. More specifically, the projections 311 may extend outwardly from the outer threads 33 of the connector 30.

In examples, the deformable portion 31 and the solid portion 32 may be made of any suitable material such as but not limited to acrylonitrile butadiene styrene (ABS), methyl methacrylate-acrylonitrile-butadiene-styrene (MABS), polyacetal (POM), polycarbonate (PC), polyethylene terephthalate (PET), or other co/-polyesters and/or other blends of the above materials. The mechanical properties of such materials allow portions 31 and 32 to be flexible, stiff, and durable as part of the connector 30. In examples, the tensile modulus is 1500-3000 MPa, more specifically of about 2250 MPa, and elongation at yield may be at least 2.5%.

In examples, and as indicatively shown in FIG. 3, the rotatable element 40 comprises a contacting surface 44, more specifically an inner contacting surface 44 that may start directly after the end of the inner threads 43 and extend towards the handle engaging portion 22 of the adaptor 20 when in use. When a user wants to engage adaptor 20 with the razor handle 50, the rotatable element 40 is rotated towards the engagement direction. During that operation, the inner threads 43 of the rotatable element 40 mate with the outer threads 33 of the connector 30. At the same time, the contacting surface 44 of the rotatable element 40 deforms the elastic projections 311 in a direction such that an end of the razor handle 50 is connected to the adaptor 20, thus significantly assisting to the connection of the adaptor 20 to the handle 50.

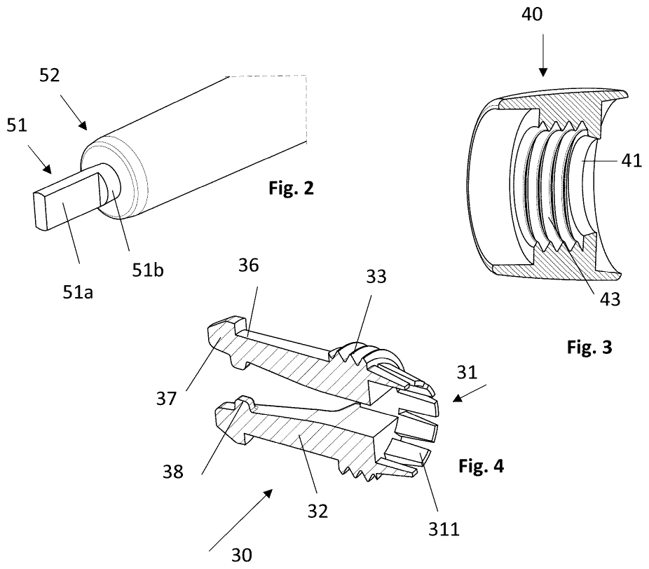

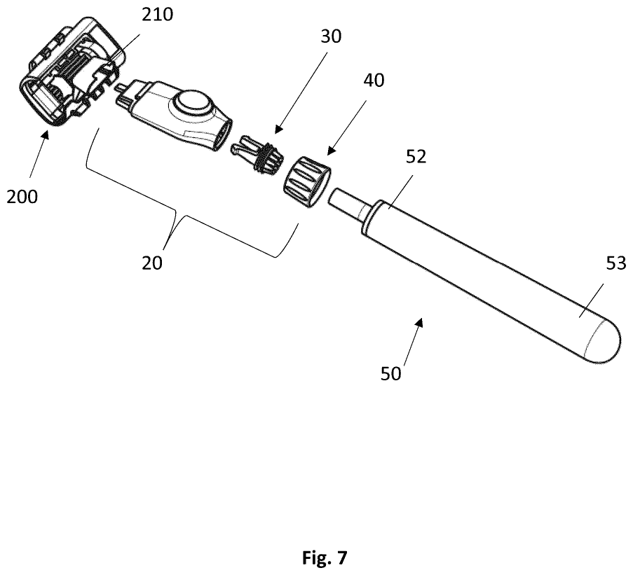

In addition, as shown in FIG. 7, a razor handle 50 is provided. The razor handle 50 extends between a distal end 52 and a proximal end 53. The distal end 52 may be considered as the end which, in use, is proximate and connected to the handle engaging portion 22 of the adaptor 20. The distal end 52 comprises a protrusion 51 with two distinct coupling regions: a cut-out surface or first coupling region 51a and a second coupling region 51b that is structurally different from the first coupling region 51a, as shown in FIG. 2. When in an engaged position, the handle 50 comprises the interconnecting mechanism substantially as described herein. The interconnecting mechanism is coupled at the distal end 52 of the handle 50. Throughout the present description and claims, “structurally different” should be understood as having a different structure, design, material and/or shape. In examples, the first coupling region 51a comprises a cut-out surface and the second coupling region 51b comprises a conical surface. “Structurally different” can also be understood as serving also different functions or purposes, in particular as it will be described below for the different coupling regions 51a and 51b.

The cut-out surface and the conical surface of the protrusion 51 of the handle 50 are configured to be received within adaptor 20. In detail, the pair of hooks 36, and consequently the connector 30, may define a channel 39 which is designed such that when a user acts to engage the handle 50 with the adaptor 20, the cut out surface 51a slides firstly within an opening of the rotatable element 40, and then within the channel 39 up to a position where the movement of the cut out surface 51a is limited by the stop structure 25 of the adaptor 20, more specifically by the projection 25b of the adaptor 20. The cut-out surface 51a therefore cannot move or slide inside beyond that position, as shown in FIG. 5B. This also acts as an indication to the user that he now has to rotate the rotatable element 40 so as to secure the distal end 52 of the handle 50 to the adaptor 20. When the user rotates the rotatable element 40 towards the engagement direction, the rotatable element 40, and more specifically the contacting surface 44, deforms the elastic projections 311 towards the conical surface 51b, up to a position where the elastic projections 311 are engaged to the conical surface 51b of the protrusion 51 of the handle 50, thereby securing the distal end 52 of the handle 50 to the adaptor 20, as shown in FIG. 5C. In examples, the shape of the channel 39 is identical to the shape of the first coupling region 51a. This configuration ensures that the first coupling region 51a can only be inserted into connector 30 and subsequently into the channel 39 with a specific orientation. This orientation is necessary to properly engage the distal end 52 of the handle 50 with the adaptor 20.

In examples, the razor handle 50 is provided with a handle grip that may be formed of a rubber, or rubber-like material, or metal, or plastic to improve gripping friction.

In examples, the cartridge engaging portion 23 comprises a stem 28 and a biasing member 27. In examples, the blade assembly comprises a further interconnecting member 210 that is configured to receive and engage with the stem 28 of the cartridge engaging portion 23 of the adaptor 20. The stem 28 may define a first recess and a second recess for selectively engaging a respective pair of cartridge protrusions that may be located on the further interconnecting member 210 of the blade assembly 200. The biasing member 27, which may have the shape of a tongue, may extend through stem 28 and may be slidable with respect to the stem 28. The biasing member 27 may be configured to contact the blade assembly 200. As shown in FIG. 5A, adaptor 20 may comprise a resilient element, in examples a spring 29, that pushes the biasing member 27 towards the blade assembly 200, thereby facilitating the pivoting of the blade assembly relative to the adaptor 20. Pivoting enables the user to adapt to a variety of contours of the body.

In examples, the adaptor 20 comprises an actuation assembly 60 that is used for locking and releasing the blade assembly 200 from the cartridge engaging portion 23. In examples, the actuation assembly 60 comprises a push member 61 that is slidably coupled with the cartridge engaging portion 23 of the adaptor 20 between a retracted position where the blade assembly is attached to the cartridge engaging portion 23 and an extended position where the blade assembly 200 is not attached to the cartridge engaging portion 23 of the adaptor 20. A button 62 may be slidably coupled with the push member 61. When the blade assembly 200 is attached to the adaptor 20, and a user actuates the button 62, the push member 61 moves towards the extended position, thus facilitating the release of the blade assembly from adaptor 20.

In examples, the blade assembly 200 comprises a guard that may be fabricated partially or completely of synthetic materials, such as plastic, resin, or elastomers. The guard comprises a leading longitudinal member and a trailing longitudinal member and at least one transverse guide member disposed in between, and joining, the leading longitudinal member and the trailing longitudinal member, in a transverse direction of the blade assembly 200. The at least one transverse guard member comprises a plurality of cutting member guides defining a plurality of cutting member support slots, each cutting member support slot configured to accommodate a longitudinal cutting member.

The blade assembly 200 may further comprise a group of cutting members accommodated in a cutting member receiving section of the guard.

Although only a number of particular embodiments and examples have been disclosed herein, it will be understood by those skilled in the art that other alternatives, obvious modifications and/or equivalents thereof are possible. Furthermore, the present disclosure aims to cover all possible combinations of the particular embodiments described. Reference signs related to drawings and placed in parentheses in a claim, are solely for attempting to increase the intelligibility of the claim and shall not be construed as limiting the scope of the claim. The scope of the present disclosure should not be limited by particular embodiments but should be determined only by a fair reading of the claims that follow.

1. An interconnecting mechanism for engaging a blade assembly to a razor handle comprising:
an adaptor extending between a handle engaging portion and a cartridge engaging portion,
a connector configured to be coupled with the handle engaging portion, the connector comprising one or more outer threads,
a rotatable element comprising one or more inner threads,
wherein the inner threads of the rotatable element are configured to mate with the outer threads of the connector.

2. The mechanism of claim 1, wherein the connector comprises a solid portion that comprises the outer threads and a deformable portion extending from the solid portion.

3. The mechanism of claim 2, wherein the deformable portion of the connector comprises one or more elastic projections.

4. The mechanism of claim 1, wherein the connector is fixedly attached to the handle engaging portion of the adaptor.

5. The mechanism of claim 3, wherein the rotatable element comprises an inner area that is configured such that when the rotatable element is rotated in an engagement direction, the inner area deforms the elastic projections thereby connecting the rotatable element to the adaptor.

6. The mechanism according to claim 1, wherein the rotatable element has a ring shape.

7. The mechanism according to claim 3, wherein the elastic projections extend outwardly from the solid portion of the connector.

8. The mechanism according to claim 1, wherein the connector comprises a pair of hooks, and the handle engaging portion of the adaptor comprises an inner wall, wherein the hooks are configured to be coupled to the inner wall.

9. The mechanism according to claim 8, wherein at least one hook of the pair of hooks comprises a finger having an angled profile with a bearing length and at least one chamfer, wherein the at least one chamfer is engaged to the inner wall.

10. The mechanism according to claim 1, wherein the adaptor comprises a stop structure that is configured to limit the movement of the connector inside the adaptor, the stop structure comprising a substantially flat surface and a projection extending from the flat surface.

11. The mechanism according to claim 10, wherein when the adaptor and the connector are in an engaged position, at least a part of the bearing length of the finger of the hooks is in contact with the flat surface of the stop structure.

12. The mechanism according to claim 8, wherein at least one hook of the pair of hooks comprises a raised portion arranged facing the other hook of the pair of hooks and configured such that a distal end of a razor handle can be connected to the adaptor.

13. The mechanism according to claim 12, wherein the raised portion comprises at least one facet, wherein the at least one facet is adapted to engage a protrusion of a razor handle.

14. A razor handle extending between a distal end and a proximal end, wherein the distal end comprises a protrusion having a first coupling region and a second coupling region that is structurally different from the first coupling region, the handle comprising the mechanism according to claim 1 coupled at the distal end of the handle.

15. The razor handle according to claim 14, wherein the first coupling region comprises a cut-out surface and the second coupling region comprises a conical surface.
